(19) United States
(12) Patent Application Publication
(10) Pub. No.: US 2018/0319230 A1
(43) Pub. Date: Nov. 8, 2018

(54) Traction Step

(71) Applicant: David Muench, Hollywood, FL (US)

(72) Inventor: David Muench, Hollywood, FL (US)

(21) Appl. No.: 15/584,066

(22) Filed: May 2, 2017

(51) Int. Cl. B60C 27/22; B60C 27/02; B60C 27/04

(52) U.S. Cl. CPC B60C 27/22; B60C 27/04; B60C 27/0238

(57) ABSTRACT

A device and method for extricating a dually vehicle from being stuck in a rut soft ground where a middle section of a tube is affixed to the outside tire leaving an inside segment against the inside dually tire and an outside segment extending perpendicularly away from the outside tire. The dually vehicle rotates the tires, then affixed to the tube, to gain traction and step up and out of the rut.

### BACKGROUND OF THE INVENTION

### 1. Field of the Invention

The present invention relates to wheeled motor vehicles, and more particularly, to a method and related device to aid vehicles getting un-stuck from a partially submerged tire.

### 2. Description of the Related Art

A truck with four wheels on a rear axle, two on each the left and right side, is sometimes referred to as a “dually”. Several designs for getting wheeled vehicles un-stuck from soft or loose ground have been designed in the past. None of them, however, includes a tube that affixes to an outside wheel on a dually and extends about a tire width perpendicularly laterally to both sides of that wheel.

Applicant believes that the closest reference corresponds to PCT patent application No. PCT/US2014/052307 by inventor Kevin Moore of Nokesville, Va. However, it differs from the present invention because the Moore invention does not extend beyond both edges of the outside wheel so it doesn't have the surface area in contact with the ground. It therefore cannot raise the vehicle out of soft ground. Moore may provide good traction on firm ground but because it has about the same area in contact with the tire to which it is attached it will not be as effective on soft ground.

Other patents describing the closest subject matter provide for a number of more or less complicated features that fail to solve the problem in an efficient and economical way. None of these patents suggest the novel features of the present invention.

A brief abstract of the technical disclosure in the specification and title are provided as well for the purposes of complying with 37 CFR 1.72 and are not intended to be used for interpreting or limiting the scope of the claims.

Without limiting the scope of the invention, a brief summary of some of the claimed embodiments of the invention is set forth below. Additional details of the summarized embodiments of the invention and/or additional embodiments of the invention may be found in the detailed description of the invention below.

### SUMMARY OF THE INVENTION

It is one of the main objects of the present invention to provide an easily deployable method and device to extricate a stuck vehicle.

It is another object of this invention to provide a device and method that a single person can use to get a vehicle un-stuck from soft ground.

It is still another object of the present invention to provide a durable and easily transportable self-help device and method that can be carried in a truck to avoid requiring assistance from a tow vehicle.

Another object of the present invention is to provide a device and method of use to free a stuck vehicle where a tow vehicle could not fit or would risk causing damage to sensitive turf.

It is yet another object of this invention to provide such a device and method that is inexpensive to manufacture and maintain while retaining its effectiveness.

Further objects of the invention will be brought out in the following part of the specification, wherein detailed description is for the purpose of fully disclosing the invention without placing limitations thereon.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 shows a perspective view of a traction step affixed to an outside wheel on a dually vehicle.

FIG. 2 shows a perspective view of a traction step affixed to an outside wheel on a dually vehicle.

FIG. 3 shows a perspective view of a traction step.

FIG. 4 shows an elevation view of a traction step on a stuck wheel.

FIG. 5 shows an elevation view of a traction step on a freed wheel.

### DETAILED DESCRIPTION OF THE PREFERRED EMBODIMENT

While this invention may be embodied in many different forms, there are described in detail herein specific embodiments of the invention. This description is an exemplary of the principles of the invention and is not intended to limit the invention to the particular embodiments illustrated and described.

For the purpose of this disclosure, like reference numerals in the figures shall refer to like features unless otherwise indicated or is obvious by context.

The subject device and method of use is sometimes referred to as the device, the invention, the step, the traction step, the tube, the machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

Generally, an important application of the traction step is for use on the rear, power axle of a dually truck. Dually vehicles have two wheels and tires on each side of the axle so that there are four tires on that axle. Duallys are used in heavy duty towing, hauling and commercial vehicle applications.

A problem can arise when a vehicle is used off a paved surface. Vehicles can get stuck. For example, hauling on a farm, a grass yard, golf course or any other place where a firm ground is absent. Similarly on a dirt or sand path, a snow covered road or other inclement condition can also cause a tire to sink into the ground and cause the vehicle to become stuck and unable to move under its own power.

In the past, drivers who become stuck have used a variety of methods to get unstuck. A tow truck can sometimes be used if conditions are right. However, sometimes the location is not amenable to a tow truck because of limited space or risk of causing more damage to sensitive turf, like on a golf course or grazing pasture. Another limiting factor for a tow truck is distance from a road or solid ground making stuck vehicle inaccessible.

Other solutions include using a vehicle mounted winch, a jack, tire chains, tire grips or stuffing wood or blankets under the stuck tire. None work in most situations. This is especially true for larger, heavier commercial vehicles.

Referring now to the drawings, where the present invention is generally referred to with numeral 10, it can be observed that it basically includes a belt 12, a ratchet 14, a tube 16, a wheel 18, a tire 20, a tire 22, an axle 24, an aperture 26, an aperture 28, an aperture 30, an interior 36, an outside segment 38, a middle segment 40 and an inside segment 42.

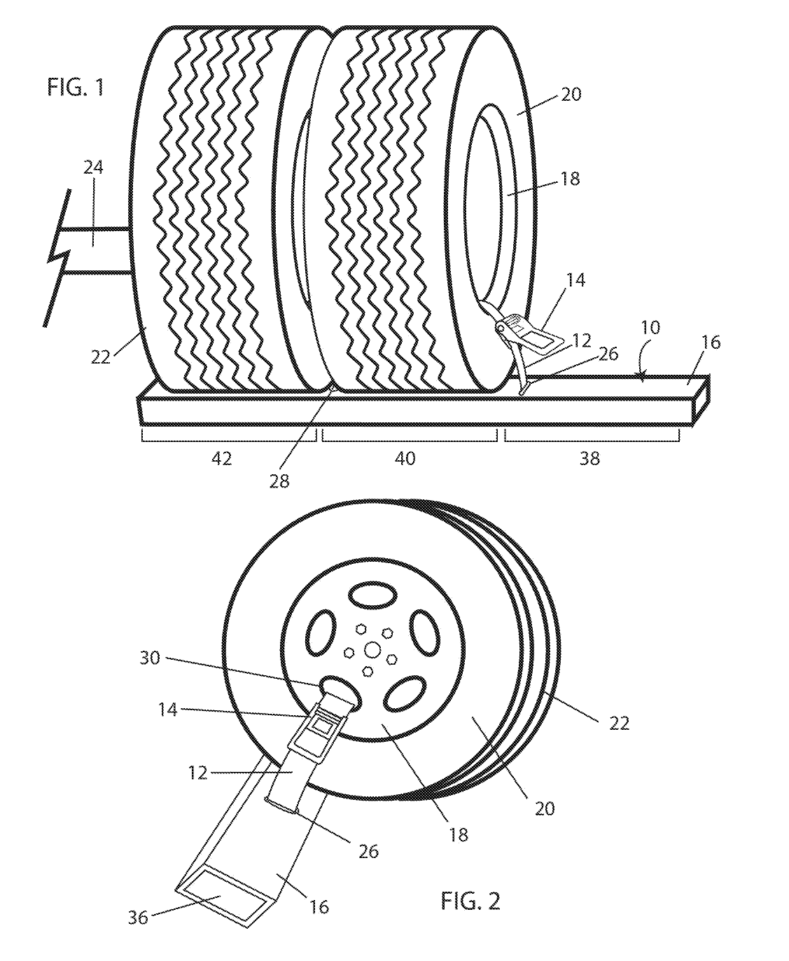

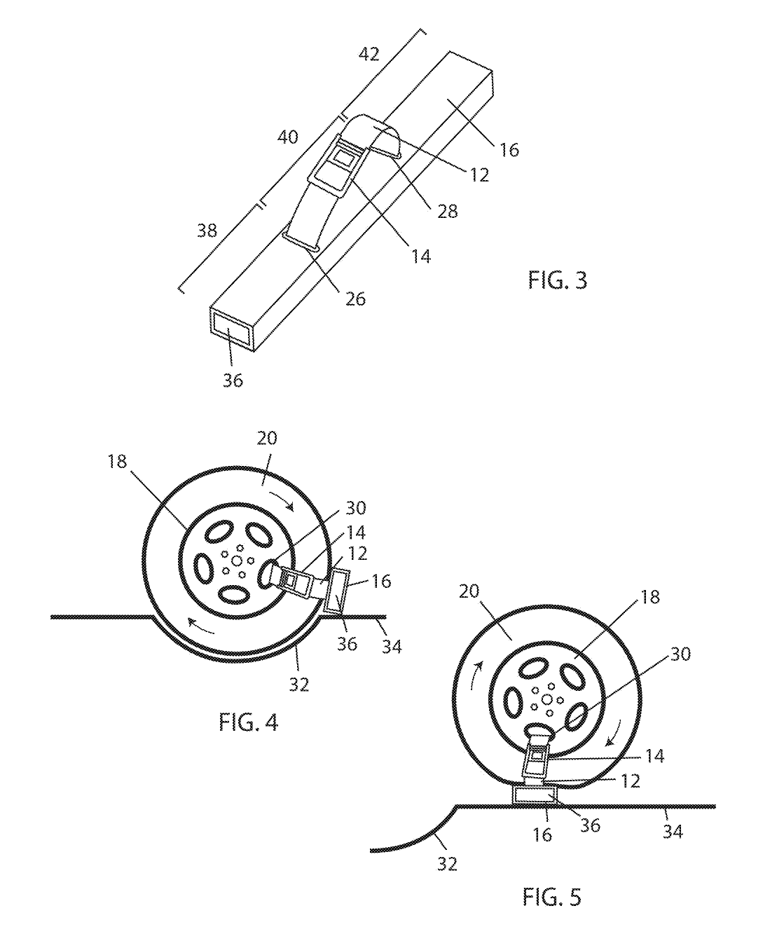

Looking at FIGS. 1, 2 and 3, an effective version of the device is demonstrated. The tube 16 is and elongated and rigid hollow structure. The cross-sectional dimensions and wall thickness of the tube 16 are sufficient to lend structural integrity so that the tube 16 does not materially flex or bend during use thereby compromising its effectiveness. The weight of the vehicle and length of the tube 16 are considerations when determining the material and dimensions of the tube 16.

An example of an effective tube 16 specification for light to medium duty dually trucks is about two by four inches of 3/16 steel having a length of about three feet. These dimensions are merely illustrative and not limiting. The dimensions can range from about half to twice these exemplary dimensions.

The material from which the tube 16 is fabricated can be steel, alloys of metal, composites or other material known to have the structural integrity to support the use of the traction step in getting vehicles un-stuck from soft ground.

If a composite material, or other materials that have differing strength characteristics, are used for the tube 16 then the wall thickness and dimensions can be altered accordingly. In some cases, use of a solid bar, instead of a hollow tube as shown, may be suitable. The tube 16 may flex or deflect a couple of inches under stress in use but should support the weight of the vehicle with load to achieve the ability to step up out a rut in expected environments.

The tube 16 is conceptually separated in three segments: the outside segment 38, the middle segment 40 and the inside segment 42. The inside segment 42 is dimensioned to correspond to the width of the inside tire 22. During use the inside segment 42 lies against the tire 22 substantially perpendicular to the tread of the tire 22. The inside segment 42 should not extend further towards the centerline of the vehicle if it could strike part of the undercarriage or wheel well of the vehicle that is anticipated to use the traction step.

The outside segment 38 is an important part of the traction step because it is a surface area of the outside segment that adds to the foot print of the tires 20 and 22. With more surface area in contact with the ground, the better the device can step the tires 20 and 22 out from a rut into which they are mired.

In addition to adding ground contact surface area with the outside segment 38, the height that the tube 16 stands off the tires 20 and 22 is an important consideration. The overall thickness of the tube 16 can act as a paddle or scoop to pull ground into the rut in which the tires 20 and 22 are stuck. This thickness should be balanced with the adverse tendency of a thicker tube 16 to gain leverage and torque away from being held against the tire 20 when in use. An effective version of the device holds the upper surface of the tube 16 firmly against the tire 20 during all phases of operation.

The middle segment 40 is about the width of the outside tire 20. The middle segment 40 is about a third of the overall length of the tube 16. Aperture 28 is positioned at about where the middle segment 40 transitions to the inside segment 42. Similarly, aperture 26 is positioned at about the boundary between the middle segment 40 and the outside segment 38. Apertures 26 and 28, in a least one version of the invention, are only on the surface of the tube 16 that lies against the tire 20 during normal use of the traction step.

The belt 12 is threaded through aperture 26 into the interior 36 of the tube 16 and out the aperture 28, or vice versa. The belt 12, in an important version of the device is a flexible, fabric strap. The belt 12 should have sufficient length to wrap around the tire 20 through the wheel 18, through the interior of the tube 16 between aperture 28 and aperture 26 and engage the bitter end functionally into the ratchet 14. For some applications the length of the belt 12 may be somewhere in the range of about four to twelve feet.

This describes some optional characteristics that may enhance an understanding of use and are merely examples. The belt 12 may perform better is constructed of a mold and mildew resistant polymer, for example polyester, nylon. The belt 12 may be colored a bright safety color to be more noticeable, for example bright orange or yellow. The width of the belt 12 should be compatible with the mechanism of the ratchet 14. The width of the belt 12 should be sufficient to ensure a tensile strength and abrasion resistance to tightly affix to the tire 20 and not appreciably degrade after repeated use extricating a vehicle from soft ground 34. For some applications the width of the belt will be in the range of about one inch to six inches with adequate thickness.

FIGS. 4 and 5 show an example of the traction step in action. In addition to the elements shown and described above and for a better understanding, contextual elements are shown to include a rut 32 and a ground 34 and an interior 36.

To use the traction step to extricate a stuck vehicle from being stuck in a rut 32 the middle segment 40 of the tube 16 is placed against the outside tire 20 on the ground 36. The long axis of the traction step tube 16 is perpendicular to the planned direction of vehicle travel out of the rut 32. The tube 16 is generally ahead of the tires 20 and 22 relative to the direction of travel out of the rut 32.

Once the tube 16 is properly positioned against the tires, where the inside segment 42 is about in front of the tire 22 and the middle segment 40 is about in front of the tire 20, leaving the outside segment 38 extending outward from the side of the vehicle, then the operator laces the belt 12 through the aperture 30 only in the outside wheel 18 and engages the bitter end of the belt 12 into the ratchet 14. The ratchet 14 is actuated to draw in the belt 12 and tightened down securely to firmly affix the tube 16 against the tire 20.

Continuing the extrication process as seen in FIGS. 4 and 5, the user of the device then, from the driver's seat engages the transmission to apply power to the wheel 18. The side of the tube 16 contacts the ground 34 ahead of the rut 32 and pulls the tire 20 out of the rut 20. The additional surface area provided by the bottom of the tube 16 by the outside segment 38 helps raise or propel the tire out of the rut 32 formed in soft ground 34 as in FIG. 5.

When the vehicle is unstuck after the tire 20 makes at least a partial rotation then the ratchet 14 may be released. The belt 12 is then pulled out from the aperture 30 in the wheel 18 and the traction step device is removed and cleaned for storage.

An important version of the device and method of use can be fairly described as a traction step for extricating a dually (four wheel on the drive axle) vehicle comprising, among other features, a tube, a belt and a ratchet. A first tire is immediately adjacent to an inside dually tire. Along a longitudinal axis (parallel to the axle) the tube has an outside segment, a middle segment and an inside segment. On an upper surface of the tube is first aperture where the outside segment meets the middle segment and a second aperture where the middle segment meets the inside segment. Along the longitudinal axis of the tube, the middle segment is dimensioned approximately a width of the first tire and may be any size between about seventy five to one hundred twenty five percent the width of the first tire. Along the longitudinal axis of the tube, the outside segment is dimensioned between about a half and three times the width of the first tire. Along the longitudinal axis of the tube, the inside segment is dimensioned approximately a width of the inside dually tire and may be any size between about seventy five to one hundred twenty five percent the width of the inside dually tire or the first tire. The belt is laced into the first aperture and out of the second aperture so that a segment of the belt is inside the tube along the middle segment. The ratchet is operatively affixed to a first end of the belt. The middle segment of the tube is placed against the first tire and the inside segment of the tube is placed against the inside dually tire the outside segment of the tube extends laterally (perpendicular to the tire path and parallel to the axle) away from the vehicle perpendicularly to a tread direction on the first tire. The belt is wrapped through the first tire and a second end of the belt is operatively engaged into the ratchet.

A variation can be described as method for extricating a dually vehicle utilizing the traction step as disclosed above further comprising, among other things, placing the middle segment of the bar against the first tire perpendicular to the tread direction of the first tire and the inside segment against the inside dually tire so that the outside segment extends perpendicularly from the first tire. Placing the belt around the first tire and operatively engaging the first and second ends of the belt into the ratchet. Operating the ratchet to affix the tube firmly against the first tire. Operating the dually vehicle to rotate the first tire along with the tube for at least a partial rotation of the first tire.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A traction step device for extricating a dually vehicle comprising a tube, a belt and a ratchet;
a first tire is immediately adjacent to an inside dually tire;
along a longitudinal axis the tube has an outside segment, a middle segment and an inside segment;
on an upper surface of the tube is first aperture where the outside segment meets the middle segment and a second aperture where the middle segment meets the inside segment;
along the longitudinal axis of the tube, the middle segment is dimensioned approximately a width of the first tire;
along the longitudinal axis of the tube, the outside segment is dimensioned between a half and three times the width of the first tire;
along the longitudinal axis of the tube, the inside segment is dimensioned approximately a width of the inside dually tire;
the belt is laced into the first aperture and out of the second aperture so that a segment of the belt is inside the tube along the middle segment;
the ratchet is operatively affixed to a first end of the belt;
the middle segment of the tube is placed against the first tire and the inside segment of the tube is placed against the inside dually tire the outside segment of the tube extends laterally away from the vehicle perpendicularly to a tread direction on the first tire;
the belt is wrapped through the first tire and a second end of the belt is operatively engaged into the ratchet.

2. A method for extricating a dually vehicle utilizing the traction step in claim 1 comprising:
placing the middle segment of the bar against the first tire perpendicular to the tread direction of the first tire and the inside segment against the inside dually tire so that the outside segment extends perpendicularly from the first tire;
lacing the belt around the first tire and operatively engaging the first and second ends of the belt into the ratchet;
operating the ratchet to affix the tube against the first tire;
operating the dually vehicle to rotate the first tire along with the tube for at least a partial rotation of the first tire.
